(19) United States
(12) Patent Application Publication
(10) Pub. No.: US 2002/0165302 A1
(43) Pub. Date: Nov. 7, 2002

(54) Method for producing additive carbon black

(76) Inventors: Rakshit Lamba, Acworth, GA (US); Grady Franklin Bradley, Cartersville, GA (US); Rodney Taylor, Acworth, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 10/014,339

(22) Filed: Dec. 10, 2001

Related U.S. Application Data
(60) Provisional application No. 60/254,406, filed on Dec. 8, 2000.

(51) Int. Cl. C08K 5/17; C08K 3/04; C09C 1/44

(52) U.S. Cl. 524/254; 524/495; 524/496; 106/476

(57) ABSTRACT

Improved carbon black and method for producing improved carbon black by combining one or more additives with carbon black in the absence of a solvent or carrier resulting in an additive carbon black (ACB). The additive may include p-phenylenediamine (PPD) and related compounds. The invention also relates to improved polymer compositions and articles of-manufacture comprised of the improved carbon black and methods for making same. Advantages provided by the improved carbon blacks made in accordance with the invention may include reduced processing time for polymer, such as rubber, compositions and articles, as well as reduced cost and environmental impact from the production of the improved carbon blacks themselves.

### CROSS REFERENCE TO RELATED APPLICATIONS

This application claims the benefit of U.S. Provisional Application No. 60/254,406, filed Dec. 8, 2000, the disclosure of which is hereby incorporated by reference.

### BACKGROUND OF THE INVENTION

1. Field of the Invention

The present invention relates generally to an improved carbon black and a method for producing the improved carbon black. The method for producing the additive carbon black comprises combining carbon black and one or more amine antidegradant additive in the absence of a solvent or carrier. The additive can include various amine antidegradants, including p-phenylenediamine (PPD) and related compounds. The invention further relates to a polymer composition comprising the improved carbon black and method of producing the composition. The invention also relates to an article-of-manufacture comprised of the improved carbon black and method of producing the article.

2. Background

Carbon black is used in many applications. For example, for many years, carbon blacks have been an essential ingredient in rubber mixtures used in the manufacture of a variety of industrial rubber products, most prominently tires. See, e.g., U.S. Pat. No. 2,867,540, Harris, assigned to Monsanto Chemical Company, issued Jan. 5,1959, MODIFIED CARBON BLACK PRODUCT AND PROCESS ('540 patent), incorporated herein by reference. Use of carbon black in tire tread formulations dramatically decreases heat generation, wear, and rolling resistance.

Improvements in manufacturing of carbon black have allowed for production of higher surface area carbon black to provide higher reinforcement and levels of wear resistance with reduction in particle size and carbon black structure (degree of branched connectivity of carbon black particles), but this higher surface area carbon black becomes harder to disperse.

Traditional carbon blacks can cause problems in rubber compounding processes. Such problems may arise from the fact that carbon black does not always disperse well into an uncured rubber mixture, thus necessitating excessive mixing. Moreover, many carbon blacks will, upon introduction, significantly increase the viscosity of rubber mixtures, thus making the blending process even more difficult.

Various attempts have been made to improve the dispersion of carbon blacks in rubber compositions. High shear and/or long mixing cycles are required to obtain optimum dispersion of fillers, such as carbon black, in rubber compositions. One technique to accomplish improved dispersion has been to mix carbon black into the polymer several times in internal mixers for short intervals each time. This provides less time for heat to be generated in the mixer, and, thus, the amount of viscosity reduction is minimized and dispersion improved. This technique increases the cost of the rubber composition was well as limiting mixing capacity.

Another technique has been to add additives to the polymer mix. A number of additives such as processing oils, antidegradants, and furazans can increase the rate of filler incorporation, enhance processability, or improve polymer to filler interactions.

Yet another technique has included alteration of the carbon black itself with addition of another compound or compounds. See, e.g., '540 patent, at col. 1, Ins. 64-66 (“The present product is also found to be more readily mixed into rubber compositions in roll mixing or Banbury mixing.”). See also, U.S. Pat. No. 4,764,547, Hatanaka et al., assigned to Bridgestone Corporation, issued Aug. 16, 1988, RUBBER COMPOSITION COMPRISING SURFACE-TREATED CARBON BLACK ('547 patent), incorporated herein by reference, at col. 7, Ins. 24-27 (“[I]n this invention the viscosity of rubber matrix filled with carbon black having a large specific area is lowered and thereby the efficiency of producing the tires is improved.”).

One approach is disclosed in a pending U.S. patent application Ser. No. 09/861,929, SURFACE TREATED CARBON BLACK HAVING IMPROVED DISPERSABILITY IN RUBBER AND COMPOSITIONS OF RUBBER THEREFROM HA VING IMPROVED PROCESSABILITY, RHEOLOGICAL, AND DYNAMIC MECHANICAL PROPERTIES, filed May 21, 2001, by inventors Lamba and Ingatz-Hoover, and incorporated herein by reference.

While the previous approaches have provided a number of more readily-dispersible, carbon black formulations, such formulations are still less than ideal for many real-world applications. For example, the '547 patent requires a drying step after treating the carbon black. See '547 patent, col. 3. Ins. 50-56, emphasis added (“Next, as the method of treating the surface of carbon black, an organic solution or liquid dispersed in water which contains the above mentioned amine or quinoline compound is poured into the carbon black in a wet-type pelletizer of carbon black. Then, the carbon black particles produced by the above method are dried at from 105° C. to 200° C. to evaporate the solvent or water.”). The Lamba/Ingatz-Hoover approach involves use of a quinone diimine (QDI) or other quinone, quinone imine, or quinone diimine additive. QDI is a proprietary and not widely available ingredient.

Accordingly, it would be highly desirable to provide a method for making improved carbon black whereby certain advantages (e.g., improved dispersion and/or viscosity reduction) could be realized using a commonly available, widely approved additive. It would also be desirable to provide a method for producing improved carbon blacks without need for solvents or carriers, and/or a drying step. The invention addresses these, as well as other, needs.

### SUMMARY OF THE INVENTION

In accordance with the purpose(s) of this invention, as embodied and broadly described herein, this invention relates to an improved carbon black and a method for producing the improved carbon black wherein carbon black is combined with neat amine antidegradant.

The invention discloses a method for producing an additive carbon black comprising combining substantially neat amine antidegradant and carbon black. The amine antidegradant may comprise naphthylamine, naphthylamine derivative, diphenylamine, diphenylamine derivative, p-phenylenediamine, p-phenylenediamine derivative, other amine compound, or a mixture thereof. The additive carbon black may be surface treated with the amine antidegradant. The carbon black may have, for example, a surface area of less than or equal to 130 m²/g.

The invention also discloses a polymer composition comprising the additive carbon black and a method for producing a polymer composition with improved carbon black dispersion characteristics comprising adding an additive carbon black made by combining carbon black and an amine antidegradant to a polymer. The composition may comprise other polymer composition ingredients.

The invention further discloses an article-of-manufacture comprising the additive carbon black. The polymeric article can comprise the polymer composition of the invention. The method of forming a polymeric article comprises producing a polymer composition by the method of the invention and subsequently forming the polymer composition into an article.

The advantages of the invention may include improved properties of carbon black that reduce processing time, improve dispersion of carbon blacks in polymer compositions and reduce the number of processing steps required during the production of polymer compositions. Further advantages of the invention may include cost and/or regulatory advantages, due to the use of widely-available and/or widely-approved additives, and/or reduced environmental impact due to the substantial absence of solvent or carrier.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### DETAILED DESCRIPTION OF THE INVENTION

Definitions

Before the present compounds, compositions, articles, devices, and/or methods are disclosed and described, it is to be understood that this invention is not limited to specific embodiments. It is also to be understood that the terminology used herein is for the purpose of describing particular embodiments only and is not intended to be limiting.

In this specification and in the claims which follow, reference will be made to a number of terms which shall be defined to have the following meanings.

It must be noted that, as used in the specification and the appended claims, the singular forms “a,” “an” and “the” include plural referents unless the context clearly dictates otherwise. Thus, for example, reference to “an amine antidegradant” includes mixtures of amine antidegradants, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed.

Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

“Additive carbon black,” (“ACB”), as used herein means an additive (chemical) is combined with a carbon black to improve carbon black performance. This is in contrast to carbon black used as a carrier for an additive. In the case of a carrier product, the chemical species can be highly loaded on the black and serves as an inert carrier for the additive. The carbon black serves only as a substrate to deliver the chemical. The performance of the product may be improved by the chemical but not by the carbon black. The total amount of the carbon black that is used to deliver the chemical, when added to, for example, a rubber composition, is insufficient to affect properties of the composition, such as abrasion resistance, modulus, tear strength, etc. The purpose of a carbon black carrier is to improve handling, delivery, incorporation/dispersion of the additive.

“Neat” as used herein means the compound per se is used as provided by the manufacturer or as synthesized, without addition to carrier, solvent or the like, i.e., not mixed or diluted.

“Derivative” as used herein means the compound has a core of the named compound and includes additional moieties that do not affect the desired functional properties of the chosen compound. The purpose of the additional moieties is simply to alter the reactivity of the core compound. Such alterations in activity may include, but are not necessarily limited to, a decrease in rate of reaction of a change in acceptable pH range of function, among other alterations.

“Substantially free” or “substantially neat” as used herein means that there may be nominal amounts of other items in the compound or composition. Residual solvents used in manufacturing, for example, may still be present, but, if present, are at relative concentrations low enough such that they do not appreciably affect the viscosity or other properties of the compound or composition.

“Combining” as used herein means mixing, surface treating, contacting, or otherwise bringing together two substances.

“Well dispersed” as used herein is a relative term depending on the end use application for the invention. In the case of the additive carbon black being “well dispersed” in a polymer, one of skill in the art may differently use this term depending on the end use application of the composition and depending on the particular components within the composition. As a general matter, it is undesirable that the additive carbon black be in clumps or otherwise poorly dispersed such that areas of the composition or article do not have the benefit of the additive carbon black.

“Optional” or “optionally” means that the subsequently described event or circumstance may or may not occur, and that the description includes instances where said event or circumstance occurs and instances where it does not. For example, the phrase “optionally additional ingredients” means that the additional ingredients may or may not be added and that the description includes both the presence and absence of additional ingredients.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

The present invention provides for the preparation of additive carbon blacks (ACBs) wherein carbon black is combined with at least one amine antidegradant additive. The additive can be naphthylamine, naphthylamine derivatives, diphenylamine, diphenylamine derivatives, p-phenylenediamine, p-phenylenediamine derivatives, other amine compounds, or a mixture thereof. These ACBs may be surface-treated by the additive. The additive carbon blacks show dramatic improvements in dispersability (as measured by both rate of dispersion and extent of dispersion), reducing mixing requirements and improved processability over carbon black not treated with an additive. The additive carbon blacks may enhance polymer compositions comprising polymers such as natural or synthetic elastomers, plastics or blends thereof and, in particular, butadiene-based rubber, providing improved reinforcement characteristics. The vulcanizates prepared therefrom may exhibit improved dynamic mechanical properties as compared to vulcanizates prepared with carbon black not treated with an additive.

Additives

The additives used in the present invention are amine antidegradants. These additives are readily commercially available. The additives act by increasing the critical energy required to initiate oxidation or ozone-induced crack growth. The effectiveness of these additives is determined by the size and nature of the nitrogen substituent. Hoffman, W. Rubber Technology Handbook, Hanser Publishers, New York, 1989. The substituents on the nitrogens stabilize the compound to greater or lesser degrees to allow donation of a hydrogen atom to oxygen species such as ozone or oxygen. This action serves to consume these species to protect polymer chains within a rubber article from attack. In addition to modifying chemical reactivity, the nitrogen substituents can also modify the mobility of the antidegradant through the polymer matrix thereby determining the level of protection offered at the surface of the article. Bulky susbtituents yield compounds that are solid at room temperature. Such an antidegradant will exhibit little mobility through the polymer matrix and will, therefore, reduce protection at the surface of a rubber article made using the compound. However, oxidative protection is improved since more of the compound will be retained inside the article as opposed to consumed at the surface. Substantially reducing the size of the substituents will yield a low viscosity liquid antidegradant with enhanced mobility of the compound within a rubber article which will improve the effectiveness as an ozone protector while diminishing the effectiveness as an oxygen protector. Intermediate between these two cases are high viscosity liquid (at room temperature) antidegradants that balance the need for ozone protection at the surface and oxygen protection in the bulk of the rubber article.

This invention may use a variety of amine antidegradants. For example, naphthylamine, naphthylamine derivatives, diphenylamine, diphenylamine derivatives, p-phenylenediamine (PPD), p-phenylenediamine derivatives, other amine compounds, or a mixture thereof may be used. The amine antidegradant is as added is substantially neat, or substantially free of added solvent or carrier.

Specifically, p-phenylenediamine derivatives may be used. It is believed that the most effective compounds for ozone and fatigue protection in rubber compositions, under static and dynamic stress, are nitrogen-substituted p-phenylenediames.

One of skill in the art would be able to determine which additive is appropriate for a particular application.

Though PPDs are used in the examples as the additive, it is intended that a very broad class of naphthylamine, naphthylamine derivatives, diphenylamine, diphenylamine derivatives, p-phenylenediamine, p-phenylenediamine derivatives and other amine compounds are suitable for use in the invention, limited primarily by considerations of practicality of physical properties of the additives or the chemical activity of or stearic hindrance caused by various substitute groups on the molecules of the additives.

Most desirable as additives in the present invention are those compounds which are liquid at room temperature or melt at temperatures substantially below their decomposition temperature. Further, desirable compounds should have relatively low vapor pressures at room temperature such that loss during additive carbon black storage will be minimized. Both factors are ultimately determined by the substituents carried on the nitrogen groups.

Examples of suitable naphthylamine derivatives which can be used include, but are not limited to, N-phenyl-1-naphthylamine, N-phenyl-2-naphthylamine, N-(3′-hydroxybutylidene)-1-naphthylamine, a reaction product of N-phenyl-2-naphthylamine and acetone (Trade Name: Antigene@ DA made by Sumitomo Chemical K.K.), and a reaction product at low temperature of N-phenyl-2-naphthylamine and acetone (Trade Name: Betanox Special made by Uniroyal Chemical Co. U.S.A.).

Examples of suitable diphenylamine derivatives which can be used include, but are not limited to, p-isopropoxydiphenylamine, bis(phenyl.iso-propylidene)-4,4′-diphenylamine, p,p′-toluene.sulfonylamino-diphenylamine, 4,4′-(α,α-dimethylbenzyl)-diphenylamine, a mixture of di-aryl-p-phenylenediamine (Trade Name: Nonflex TP made by Seiko Chemical K.K.), N,N′-diphenylethylenediamine, N,N′-diphenylpropylenediamine, a reaction product at high temperature of diphenylamine and acetone (Trade Name: Noclac B made by Ouchi Chemical Industry K.K.), a reaction product at low temperature of diphenylamine and acetone (Trade Name: Aminox® made by Uniroyal Chemical Co. U.S.A.), a reaction product at low temperature of diphenylamine-aniline and acetone (Trade Name: Nonflex BAR made by Seiko Chemical K.K.), a reaction product of diphenylamine and diisobutylene (Octamine® made by Uniroyal Chemical Co.), octylated diphenylamine (Trade Name: Noclac AD made by Ouchi Shinko Chemical Industry, Trade Name: Antioxidant OCD made by Bayer Co. West Germany, Trade Name: Flectol® ODP made by Monsanto Co. U.S.A.), nonylated diphenylamine (Trade Name: Polylite® made by Uniroyal Chemical Co. U.S.A.), displaced diphenylamine (Trade name: Antioxidant 445 made by Uniroyal Chemical Co. U.S.A.), alkylated diphenylamine (Trade Name: Noclac ODA made by Ouchi Chemical Industry K.K., Trade name: Antioxidant AD made by Anker Chemical Co.), a mixture of alkylated diphenylamine (Trade Names: AgeRite® Stalite®, AgeRite® Stalite® S, and AgeRite® Nepa made by Vanderbilt Co. U.S.A.), a blend of the mixture of diphenylamine and petroleum wax (Trade Name: AgeRite® Gel made by Vanderbilt Co. U.S.A.) and derivatives of diphenylamine (Trade Names: Antage OD, Antage LDA made by Kawaguchi Chemical Co., Trade Name: Antioxidant DDA made by Bayer Co. West Germany).

Examples of suitable p-phenylenediamine derivatives which can be used include, but are not limited to, N,N′-diphenyl-p-phenylenediamine, N′-di-2-naphthyl-p-phenylenediamine, N,N′-bis(1-methylheptyl)-p-phenylenediamine, N,N′-bis(1,4-dimethylpentyl)-p-phenylenediamine, N,N′-bis(1-ethyl-3-methylpentyl)-p-phenylenediamine, N,N′-diaryl-p-phenylenediamine, N-isopropyl-N′-phenyl-p-phenylenediamine, N-cyclohexyl-N′-phenyl-p-phenylenediamine, N-alkyl-N′-phenyl-p-phenylenediamine, N-alkyl-N′-aryl-p-phenylenediamine, N-4-methyl-2-pentyl-N′-phenyl-p-phenylenediamine, N-(1,3-dimethylbutyl)-N′-phenyl-p-phenylenediamine, N-(1-methylheptyl)-N′-phenyl-p-phenylenediamine, N-phenyl-N′-(3-methacryloyloxy-2-hydroxypropyl)-p-phenylenediamine, hindered.diaryl-p-phenylenediamine, phenylhexyl-p-phenylenediamine, phenyloctyl-p-phenylenediamine and a mixture of diaryl-p-phenylenediamine (Trade Name: Antage ST-1 made by Kawaguchi Chemical K.K., Trade name: Noclac 630 and Noclac 660 made by Ouchi Shinko K.K.).

Examples of suitable other amine compounds which can be used include, but are not limited to, N,N′-di-o-toryl.ethylenediamine, N,N′-disarylcilidene-1,2-propanediamine, a reaction product of amine and ketone (Trade Name: Antigene® FR, Antigene® AS made by Sumitomo Chemical K.K.), derivatives of aromatic amines (Trade Name: Anti-Aging ADD made by A.C.N.A. Italy) and a condensation product of butylaldehyde and aniline (Trade Name: Antox Special made by Du Pont Co. U.S.A.).

Carbon Black

The carbon blacks used in the invention can be any carbon black in any form. For example, the following ASTM classifications may be used N110, N115, N120, N121, N125, N134, N135, S212, N220, N231, N234, N293, N299, S315, N326, N330, N335, N339, N343, N347, N351, N356, N358, N375, N539, N550, N582, N630, N642, N650, N660, N683, N754, N762, N765, N772, N774, N787, N907, N908, N990, N991. These carbon blacks have nitrogen surface areas (NSA) ranging, for example, from about 8 m²/g to about 143 m²/g. Surface areas of about 8, 9, 25, 29, 30, 32, 34, 35, 36, 39, 40, 71, 77, 78, 80, 85, 89, 91, 93, 94, 96, 104, 110, 111, 119, 120, 122, 126, 127, 130, 134, 141, or 143 m²/g can be used, for example. More specifically, N121, N220, N326, N339, N375 may be used with surface areas of about 77, 94, 96, 110, or 119 m²/g. Additive carbon blacks with NSAs of less than or equal to 130 m²/g show improved dispersion in polymer compositions. The carbon blacks may be powdered, pelletized, beaded, or any other form that is appropriate for the particular application. Carbon blacks are readily commercially available and one of skill in the art will be able to determine the appropriate carbon black for the particular application.

Additive Carbon Black (ACB)

An effective amount of additive is combined with the carbon black. An effective amount is that which produces the desired results in the end use application of the ACB but does not interfere with the desired physical properties in the end use application, such as in rubber articles comprising the ACB. Effective amounts will vary with polymer type. For example, unsaturated diene polymers (e.g., NR, SBR) are more susceptible to oxidative degradation than unsaturated polymers (e.g., EPDM). In cases where the polymer has little susceptibility to oxidative attack, the effective amount of additive becomes that which is required to enhance dispersion of the carbon black. In other cases, the overriding concern is the amount of additive required to protect the polymer from attack. For example, addition of from about 0.01 to about 8 parts by weight of additive relative to 100 parts by weight of carbon black can be used. Specifically, this ratio can be, for example, about 2 to about 50 parts by weight or about 1.8 to about 45 parts by weight additive to carbon black. The ratios of additive to carbon black can vary. For example, the parts by weight of additive can be, for example, about 0.01, 0.02, 0.05, 0.1, 0.2, 0.5, 1, 1.2, 1.5, 2, 2.3, 2.5, 3, 3.4, 3.5, 4, 4.5, 4.6, 5, 5.5, 5.8, 6, 6.5, 6.9, 7, 7.5, or 8 to about 100 parts by weight carbon black. To form the ACB the additive may be combined with carbon black, for example, beads or powder, by spraying the carbon black with the additive at a temperature of from at or above the melting point of the additive to a temperature at or below the decomposition temperature of the additive. Any other method of combining the additive and carbon black which retains the desired end characteristics may be used. Additional methods of combining the additive and carbon black are known to or can be determined by one of skill in the art. For example, the additive and carbon black may be combined in a beader. The carbon black may be surface treated with the additive to form the ACB.

The additive is generally combined with the carbon black neat, i.e., without a solvent or carrier. However, the additive need only be substantially free of an added solvent or carrier (substantially neat). A nominal amount of solvent or carrier, such as water or an organic solvent, can be present without adversely affecting the resulting ACB. A nominal amount of solvent or carrier will likely be evaporated from the heat of an internal mixer when the ACB is added to a polymer. A “nominal amount” is, for example, that which is combined with the additive azeotropically and cannot be removed without substantial effort of residual solvent from the manufacturing process used to make the additive. Additionally, water that is present on the surface of the carbon black prior to application of the additive (i.e., residual water from the beading process or atmospheric moisture absorbed or absorbed onto the surface of the carbon black) should be considered as a “nominal amount” as it is commonly present on all grades of carbon black whether containing an additive or not. A level of 5% by weight solvent or carrier may be considered a “nominal amount,” more typically a nominal amount will be 1-2% by weight or less.

By not adding a solvent or carrier to the additive, a drying step is not needed for the ACB. It is believed that a drying step, such as in the '547 patent, will result in a reduction in amount and/or effectiveness of the antidegradant. This may be a result of evaporation and/or additional changes in the antidegradant itself in addition to the solvent or carrier. Additionally, other benefits of not adding a solvent or carrier may include time and cost savings and thus higher throughput. The absence of a solvent also reduces environmental impact, especially in the case of an organic solvent. Additional benefits may result as well.

The additive can be added to the carbon black at any point from the production site of the carbon black up to prior to mixing of the additive carbon black with another material, such as a polymer. Such mixing may occur, for example, at the entrance of the mixing device in which the additive carbon black and polymeric material are mixed.

Polymer Composition

The invention provides a polymer composition comprising the additive carbon black made by the method of the present invention.

The polymer(s) of the polymer composition may be any polymer suitable for the particular application. For example, the polymer may be an elastomer or a plastic-type polymer. Specifically, for example, the polymer may be rubber.

If the polymer is rubber, the rubber(s) utilized in accordance with the present invention may contain natural rubber (NR) and/or synthetic rubbers. Blends of a polyisoprene rubber with one or more other rubbers such as polybutadiene rubber or butadiene rubber (BR), styrene-butadiene rubber (SBR), and a mixture of BR or SBR may also be used.

The ACB of the invention is added to the polymer at any amount appropriate for the particular application. One of ordinary skill in the art would be able to determine the amount. For example, the ACB may be added at about 10 to about 80 parts by weight additive carbon black per hundred parts by weight rubber (phr), about 20 to about 60 phr carbon black, or about 40 to about 60 phr carbon black. The ACB may be added, for example, at about 10, 12, 15, 17, 20, 25, 27, 30, 32, 35, 37, 40, 42, 45, 47, 50, 52, 55, 57, 60, 62, 65, 67, 70, 72, 75, 77, or 80 phr.

The polymer composition of the present invention may further comprise an additional ingredient. For example, vulcanizer (e.g., sulfur), cure activator, accelerator, antioxidant, antiozonants, softener, oil, processing aids (such as fatty acids or fatty acid derivatives), wax, filler, peptizers, plasticizers, reodorants, acid scavengers, low molecular weight polymers, radical traps, resins, and the like. Liquid ingredients can include, for example, a softener, oil, plasticizer, reodorant, low molecular weight polymer, curable resin, prepolymeric liquids, peroxides, or reodorant. Dry ingredients can include, for example, a vulcanizer, cure activator, accelerator, filler, fatty acid, fatty acid derivative, was, peptizer, antioxidant, antiozonants, or acid scavengers. Ingredients which are commonly either liquid or dry can include, for example, an antioxidant, antiozonant, or resin. These additional ingredients are readily commercially available and are conventional in the art.

The polymer composition may further be produced by adding an additional ingredient to the composition comprising polymer and the ACB. The additional ingredient(s) is/are added at amounts appropriate for the particular application. One of ordinary skill in the art would be able to readily determine the amount(s).

A sulfur-vulcanized rubber composition made in accordance with the invention contains, for example, about 10 to about 80 parts per hundred rubber (phr) additive carbon black, about 20 to about 60 phr additive carbon black, or about 40 to about 60 phr additive carbon black.

The polymer composition is generally mixed until the ACB is well dispersed in the polymer.

This method may further comprise milling, cooling, extruding, calendering, pelletizing, granulating, grinding, sheeting, or otherwise preparing the polymer composition for downstream use, storage, or shipment as an intermediate or final product.

The cooling may, for example, be performed on a two roll mill, twin screw sheeter, or other apparatus for forming thin sheets or pellets which facilitate cooling for temporary storage.

Polymeric Article

The invention provides a polymeric article comprising the polymer composition of the invention comprising the additive carbon black made by the method of the present invention.

The polymeric article(s) are produced by making a polymer composition by the method of the invention and subsequently forming the polymer composition into an article. It may also be possible to simultaneously form the polymer composition and the resulting article.

The article may be formed by processes known to one of skill in the art, for example, by extrusion, molding, calendering, rolling, or stamping.

Polymeric articles may include, for example, tire treads or sheets of rubber that comprise the polymer composition of the invention.

The article may comprise other components as well.

### EXAMPLES

The following examples are given for the purpose of further illustration of this invention. They are not to be construed, however, as limiting the scope of this invention. In this application, the abbreviation “phr” means the number of parts by weight per 100 parts by weight of the referenced material, such as carbon black, or rubber. For example, in the case of a rubber blend, it would be based on 100 parts by weight of total rubber. Conventional rubber compounding materials, conditions, temperatures, procedures and evaluation techniques are used, unless noted to the contrary.

### Examples 1-3

Methods and Materials

Additive Carbon Black (ACBs)

Three different types of additive carbon blacks were prepared that using 6-QDI (N-phenyl-N′-1,3-dimethylbutyl-p-quinonediimine) (Flexsys America L.P., Akron, Ohio) (6-QDI ACB), Vulkanox® 4030 (N,N′-bis-(1,4-dimethylpentyl)-p-phenylenediamine) (77-PD) (Bayer Aktiengesellschaft Corporation, Leverkusen-Bayerwerk, Germany) (V4030-ACB) and Vulkanox® 4020 (N-(1,3-dimethylbutyl)-N′-phenyl-p-phenylenediamine) (6-PPD) (Bayer Aktiengesellschaft Corporation, Leverkusen-Bayerwerk, Germany) (V4020-ACB) as additives at 4.0 phCB. For comparison to untreated carbon black, 50 phr of carbon black treated with the equivalent of 2.0 phr of additive were substituted for 50 phr of untreated carbon black and 2.0 phr of free 6-PPD.

These additive carbon blacks were prepared by directly spraying the additives onto the surface of the carbon black. The additive was applied using a DeVilbiss (Maumee, Ohio) Spray Gun equipped with a 2.8 mm spray tip operating at 25 psi. This apparatus can be outfitted with a hose heater to facilitate spraying high viscosity materials and the operating pressure can be increased or decreased to control throughput of the additive. The additive is held in a spray pot before being forced through the hose to the spray tip. The spray pot can be heated for high viscosity materials/solids. The carbon black is placed into a drum with an opening at one end. The drum is then placed on a roller mill. The drum is then rotated while additive is sprayed through the opening. The weight of the pot is monitored with a bench top weight scale. When the desired amount of material has been delivered to the carbon black, the spray is stopped.

Tables 1-3 illustrate some of the various rubber compositions of this invention comprising the additive carbon black of the invention.

Rubber Compositions

The compounding recipes of rubber compositions used in Examples 1-3 are as follows:

TABLE 1
Tread Recipes.
Natural Rubber (NR) Tread Recipe

| | Control | 6-QDI | Additive carbon |
|---|---|---|---|
| Ingredient | (6-PPD in situ) | in situ | black compounds |
| SMR CV-60† | 100.0 | 100.0 | 100.0 |
| N121‡ Carbon | 50.0 | 50.0 | — |
| black | | | |
| N121 ACB* | — | — | 52.0 |
| Zinc oxide | 4.0 | 4.0 | 4.0 |
| Stearic acid | 1.5 | 1.5 | 1.5 |
| Shellmax ® 400** | 1.0 | 1.0 | 1.0 |
| 6-PPD | 2.0 | — | — |
| 6-QDI | — | 2.0 | — |
| Santocure ® | 1.6 | 1.6 | 1.6 |
| TBBS*** | | | |
| Sulfur | 1.2 | 1.2 | 1.2 |

†Standard Malaysian rubber with viscosity controlled to 60 Mooney units.
‡ASTM Classification for carbon black. The ASTM Classification system for carbon black is hereby incorporated by reference.
*The additive carbon blacks (ACBs) were treated with 6-QDI, Vulkanox ® 4020 or Vulkanox ® 4030.
**Microcrystalline wax, Shell Lubricants Shell Chemical Company, Houston, TX.
***N-tert-Butyl-2-benzothiazolesulfenamide, accelerator, Flexsys America, L.P., Akron, OH.

Emulsion and Solution SBR Recipes

| | Control | 6-QDI | Additive carbon |
|---|---|---|---|
| Ingredient | (6-PPD in situ) | in situ | black compounds |
| SBR** | 100.0 | 100.0 | 100.0 |
| N121 carbon black | 50.0 | — | 50.0 |
| N121 ACB* | — | 52.0 | — |
| Zinc oxide | 3.0 | 3.0 | 3.0 |
| Stearic acid | 2.0 | 2.0 | 2.0 |
| Shellmax ® 400 | 2.0 | 2.0 | 2.0 |
| Sundex 8125† | 10.0 | 10.0 | 10.0 |
| 6-PPD | 2.0 | — | — |
| 6-QDI | — | — | 2.0 |
| Santocure ® | 1.3 | 1.3 | 1.3 |
| MOR*** | | | |
| Methyl Tuads‡ | 0.3 | 0.3 | 0.3 |
| Sulfur | 1.6 | 1.6 | 1.6 |

*The additive carbon blacks (ACBs) were treated with 6-QDI, Vulkanox ® 4020, or Vulkanox ® 4030, as indicated.
**The emulsion SBR (ESBR) used was Goodyear SIBR 1500 and the solution SBR (SSBR) was Goodyear Solflex 1216.
†Highly aromatic extender oil, Sun Refining, Philadelphia, PA.
***Accelerator, 2-benzothiazoyl-N-morpholinosulfide, Flexsys America L.P., Akron, OH.
‡Vulcanizing agent, sulfur donor, R. T. Vanderbilt Company, Inc., Norwalk, CT.

Testing

The characteristics of the carbon black and rubber compositions were evaluated by the following methods:

(1) MDR Rheology ASTM D5289

(2) Dispersion Index Masterbatch LS5-402 (ASTM D2663 Method C)

(3) Mixing Characteristics (° C., RPM, min., FF)

(4) Viscosity and Scorch ASTM D1646

(5) Viscosity ASTM D1646

(6) Apparent Viscosity—MPT ASTM D5099

(7) Stress Strain Characteristics ASTM D412

(8) Zwick Rebound (%) ASTM D1054

(9) Shore A Durometer Hardness ASTM D2240-97

Masterbatch Preparation

In the following examples, an internal mixer such as the Banbury mixer, was used. The usual technique is to add various materials, often in portions, to the mixer and continue mixing for the indicated time period. Further additions followed by mixing were then made to the masterbatches thus prepared. The standard technique operated according to the following schedule:

(1) In the in-situ 6-PPD, 6-PPD was added with the first untreated carbon black addition.

(2) In the QDI-ACB, carbon black was surface treated with QDI.

(3) In the Vulkanox® 4030 ACB, carbon black was surface treated with Vulkanox® 4030.

(4) In the Vulkanox® 4020 ACB, carbon black was surface treated with Vulkanox® 4020.

(5) In the in-situ 6-QDI, 6-QDI was added with the first untreated carbon black addition.

Mixing

TABLE 2
Mix Cycle for SSBR and ESBR Recipes.
Stage 1
(Banbury at 100° F., 77 rpm, SSBR 70% fill factor, ESBR 80% fill factor)

| Step | Operation | Time | Temperature |
|---|---|---|---|
| 1 | Add polymer | 0 | |
| 2 | Add ½ carbon black and dry | 0.5 | |
| | ingredients | | |
| 3 | Add ½ carbon black and oil | 1.5 | |
| 4 | Sweep | 2.5 | |
| 5 | Dump | 3.5 min ESBR | 320° F. |
| | | 4.0 min SSBR | |
| 6 | Pass through 2x without banding | | Mill |
| | and cool 1 hr. min. | | T = 350° C. |

Stage 2
(Banbury at 100° F., 50 rpm)

| Step | Operation | Time (sec) | Temperature |
|---|---|---|---|
| 1 | Add masterbatch | 0 | |
| 2 | Add cure | 30 | |
| 3 | Drop | 90 | 220° F. |

Set mill temp at 35° C.

Band for 30 sec

X cut and roll 6×

Roll end for end 3×

Band sheet off for s/s

TABLE 3
Mix Cycle for NR Recipes.
Stage 1
(Banbury at 100° F., 65 rpm, 70% fill factor)

| Step | Operation | Time | Temperature |
|---|---|---|---|
| 1 | Add polymer | 0 | |
| 2 | Add ½ carbon black and dry | 0.5 | |
| | ingredients | | |
| 3 | Add ½ carbon black and oil | 1.5 | |
| 4 | Sweep | 2.5 | |
| 5 | Dump | 3.5 | 320° F. |
| 6 | Pass through 2x without banding | | Mill T = 70° C. |
| | and cool 1 hr. min. | | |

### Stage 2

Heat batches at 80° C. for 30 min prior to milling

Set mill temp at 70° C.

Band for 30 sec

Add cure; do not cut until cure incorporated

X cut and roll 6×

Roll end for end 3×

Band sheet off for s/s

### Example 1

### ESBR Formulation Comparisons

An ESBR-based rubber formulation was prepared by mixing with a Farrell 00 Banbury equipped with a kilowatt-hour power integrator. The mix cycle called for two carbon additions including oil with the second carbon black addition, if any oil was called for in the recipe. Cooling water was set at 38° C. for all mixing. The ESBR fill factor was 80%. The ESBR compounds were mixed at a 77 rpm rotor speed (Table 2 details the mixing procedure). Total mixing energy was recorded with each batch as well as actual batch temperature using an insertion probe pyrometer. After being dropped from the mixer all batches were passed twice (without banding to minimize work input) through an 8×18″ two roll mill for cooling. At this point, small portions were sampled from each masterbatch and placed in a saturated methanol/dicumyl peroxide solution. These batch samples were then press-cured and tested for carbon black dispersion using the Surfanalyzer® (Federal Instruments, Providence, R.I.).

Accelerators and curing agents were added to the ESBR in the second Banbury pass followed by further mixing and cooling on the two-roll mill set at 35° C. All batches were sheeted off at approximately 2.5 mm to the formulations to facilitate making slabs for testing. The results of the measurements are summarized in the following Table 4.

TABLE 4
Results From ESBR Batches Banbury Mixed to 3.5 Minutes.

| | | | PPD ACB | | |
|---|---|---|---|---|---|
| | In situ | | Vulkanox ® | Vulkanox ® | In situ |
| | 6-PPD | QDI-ACB | 4030 ACB | 4020 ACB | 6-QDI |
| Carbon black A # | A-14432 | A-19630 | A-19629 | A-19628 | A-14432 |

MDR Rheology at 153° C.
ASTM D5289

| | | | | | |
|---|---|---|---|---|---|
| M_{L} (dNm) | 1.9 | 2.1 | 2.1 | 2.0 | 2.0 |
| M_{H} (dNm) | 18.5 | 19.7 | 19.0 | 19.3 | 18.7 |
| M_{H}-M_{L} (dNm) | 16.5 | 17.6 | 16.9 | 17.3 | 16.7 |
| Ts2 (minutes) | 7.61 | 6.57 | 4.98 | 7.65 | 5.91 |
| T90 (minutes) | 15.8 | 13.03 | 9.81 | 14.63 | 11.85 |
| Cure rate | | | | | |
| (dNm/min) | | | | | |

Dispersion Index
Masterbatch
ASTM D2663

| | | | | | |
|---|---|---|---|---|---|
| F | 70 | 59 | 59 | 49 | 53 |
| H | 2.5 | 2.4 | 2.9 | 2.3 | 2.3 |
| F²H | 13084 | 8096 | 9941 | 5780 | 6981 |
| DI | 79.8 | 83.9 | 81.3 | 86.8 | 85.3 |
| SD | 3.5 | 3.1 | 5.5 | 3.3 | 3.3 |

Mixing Characteristics
(100° F., 65 rpm, 3.5 min, 80% FF)

| | | | | | |
|---|---|---|---|---|---|
| Drop Temperature | 155 | 158 | 161 | 169 | 171 |
| Mixing energy | 133.6 | 154.8 | 149.5 | 146.4 | 137.2 |
| (W*Hr) | | | | | |

Viscosity and Scorch
At 121° C.
ASTM D1646

| | | | | | |
|---|---|---|---|---|---|
| MV initial | 76 | 72 | 73 | 71 | 70 |
| ML1+4 | 48 | 47 | 48 | 46 | 46 |
| MV minimum | 44 | 45 | 46 | 43 | 43 |
| Ts2 (min) | 43.91 | 33.26 | 27.19 | 45.49 | 37.21 |
| Ts5 (min) | 48.52 | 41.74 | 29.76 | 49.22 | 40.95 |

Viscosity at 100° C.
ASTM D1646

| | | | | | |
|---|---|---|---|---|---|
| MV initial | 97 | 92 | 95 | 90 | 90 |
| ML1+4 | 61 | 61 | 63 | 60 | 59 |

Apparent Viscosity-MPT
ASTM D5099

| | | | | | |
|---|---|---|---|---|---|
| Shear rate (s⁻¹) | | | | | |
| 21.9 | 8269 | 7910 | 8229 | 8029 | 7710 |
| 102.2 | 3612 | 3552 | 3655 | 3518 | 3484 |
| 456.0 | 1390 | 1281 | 1302 | 1256 | 1264 |
| 2029.4 | 375 | 379 | 387 | 370 | 373 |

Stress Strain Characteristics
ASTM D412

| | | | | | |
|---|---|---|---|---|---|
| M100% | 2.7 | 2.9 | 2.8 | 2.7 | 2.8 |
| M200% | 7.3 | 7.5 | 7.2 | 7.4 | 7.5 |
| M300% | 13.2 | 13.3 | 12.7 | 13.4 | 13.4 |
| Tensile | 22.8 | 21.8 | 23.2 | 22.7 | 24.1 |
| Elongation at break | 460 | 450 | 480 | 450 | 470 |
| (%) | | | | | |
| Zwick Rebound | 39.9 | 40.7 | 40.3 | 40.6 | 40.7 |
| (%) | | | | | |
| ASTM D1054 | | | | | |
| Shore A | 66 | 65 | 65 | 64 | 63 |
| Durometer | | | | | |
| Hardness | | | | | |
| ASTM D2240-97 | | | | | |

### Example 2

### NR Formulation Comparisons

A NR-based rubber formulation was prepared by mixing with a Farrell 00 Banbury equipped with a kilowatt-hour power integrator. The mix cycle called for two carbon additions including oil with the second carbon black addition, if any oil was called for in the recipe. Cooling water was set at 38° C. for all mixing. The NR fill factor was 70%. The NR compounds were initially mixed at a 77 rpm rotor speed but it was found that all batches exhibited first pass carbon black dispersions greater than 90, which did not allow discrimination of the effects of the carbon black (Table 3 details the mixing procedure). It was found that the 65 rpm rotor speed produced a lower dispersion level in the control allowing differentiation between the effects of the various carbon black treatments. Total mixing energy was recorded with each batch as well as actual batch temperature using an insertion probe pyrometer. After being dropped from the mixer, all batches were passed twice (without banding to minimize work input) through an 8×18″ two roll mill for cooling. At this point, small portions were sampled from each masterbatch and placed in a saturated methanol/dicumyl peroxide solution. These batch samples were then press-cured and tested for carbon black dispersion using the Surfanalyzer®.

In the second Banbury pass, the NR batches were preheated to 80° C. for 0.5 hours in an oven and then finished on an 8×18″ two-roll open mill with roll temperatures set at 70° C. All batches were sheeted off at approximately 2.5 mm to the formulations to facilitate making slabs for testing.

The results of the measurements are summarized in the following Table 5.

TABLE 5
Results from NR Batches Banbury Mixed to 3.5 Minutes.

| | | | PPD ACB | | |
|---|---|---|---|---|---|
| | In situ | | Vulkanox ® | Vulkanox ® | In situ |
| | 6-PPD | QDI-ACB | 4030 ACB | 4020 ACB | 6-QDI |
| Carbon black A # | A-14432 | A-19630 | A-19629 | A-19628 | A-14432 |

MDR Rheology at 153° C.
ASTM D5289

| | | | | | |
|---|---|---|---|---|---|
| M_{L}(dNm) | 3.2 | 3.0 | 3.3 | 3.3 | 3.1 |
| M_{H}(dNm) | 20.3 | 20.5 | 20.2 | 20.0 | 20.4 |
| M_{H}-M_{L}(dNm) | 17.1 | 17.5 | 16.9 | 16.7 | 17.3 |
| Ts2 (minutes) | 4.87 | 4.47 | 2.70 | 3.94 | 5.76 |
| T90 (minutes) | 8.76 | 8.71 | 5.52 | 7.41 | 11.3 |
| Cure rate | | | | | |
| (dNm/min) | | | | | |

Dispersion Index
Masterbatch
ASTM D2663

| | | | | | |
|---|---|---|---|---|---|
| F | 51 | 27 | 18 | 23 | 51 |
| H | 2.3 | 2.4 | 2.3 | 2.4 | 2.3 |
| F²H | 5814 | 1735 | 744 | 1247 | 5872 |
| DI | 77.2 | 91.2 | 95.5 | 93.3 | 77.1 |
| SD | 3.3 | 3.8 | 2.7 | 3.2 | 3.8 |

Mixing characteristics
100° F., 65 rpm, 3.5 min

| | | | | | |
|---|---|---|---|---|---|
| Drop temp | 138 | 133 | 127 | 130 | 132 |
| Mixing energy | 110.8 | 111.7 | 111.6 | 109 | 106.6 |
| (W*Hr) | | | | | |

Viscosity and Scorch at 121° C.
ASTM D1646

| | | | | | |
|---|---|---|---|---|---|
| MV initial | 115 | 104 | 109 | 110 | 111 |
| ML1+4 | 78 | 73 | 178 | 77 | 74 |
| MV minimum | 72 | 67 | 75 | 73 | 69 |
| Ts2 (min) | 25.43 | 24.79 | 11.21 | 22.09 | 33.89 |
| Ts5 (min) | 26.46 | 26.54 | 15.19 | 23.45 | 35.03 |

Viscosity at 100° C.
ASTM D1646

| | | | | | |
|---|---|---|---|---|---|
| MV initial | 177 | 145 | 163 | 175 | 156 |
| ML1+4 | 92 | 86 | 89 | 88 | 87 |

Apparent viscosity-MPT
ASTM D5099

| | | | | | |
|---|---|---|---|---|---|
| Shear rate (s⁻¹) | | | | | |
| 21.9 | 10466 | 9667 | 9907 | 9787 | 9627 |
| 102.2 | 3741 | 3433 | 3544 | 3466 | 3390 |
| 456.0 | 1126 | 1081 | 1200 | 1122 | 1081 |
| 2029.4 | 544 | 505 | 635 | 609 | 514 |

Stress Strain Characteristics
ASTM D412

| | | | | | |
|---|---|---|---|---|---|
| M100% | 3.9 | 3.8 | 3.4 | 3.6 | 3.8 |
| M200% | 10.6 | 10.2 | 8.9 | 9.5 | 10.3 |
| M300% | 17.8 | 17.0 | 15.4 | 16.5 | 17.5 |
| Tensile | 31.0 | 30.7 | 28.8 | 31.0 | 30.6 |
| Elongation at break | 540 | 550 | 520 | 550 | 520 |
| (%) | | | | | |
| Zwick Rebound | 54.1 | 51.7 | 53.3 | 53.5 | 53.1 |
| (%) | | | | | |
| ASTM D1054 | | | | | |
| Shore A | 67 | 67 | 67 | 67 | 68 |
| Durometer | | | | | |
| Hardness | | | | | |
| ASTM D2240-97 | | | | | |

### Example 3

### SSBR Formulation Comparisons

A SSBR-based rubber formulation was prepared by mixing with a Farrell 00 Banbury equipped with a kilowatt-hour power integrator. The mix cycle called for two carbon additions including oil with the second carbon black addition, if any oil was called for in the recipe. Cooling water was set at 38° C. for all mixing. The SSBR fill factor was 70%. The SSBR compounds were mixed at a 77 rpm rotor speed (Table 2 details the mixing procedure). Total mixing energy was recorded with each batch as well as actual batch temperature using an insertion probe pyrometer. After being dropped from the mixer, all batches were passed twice (without banding to minimize work input) through an 8×18″ two roll mill for cooling. At this point, small portions were sampled from each masterbatch and placed in a saturated methanol/dicumyl peroxide solution. These batch samples were then press-cured and tested for carbon black dispersion using the Surfanalyzer®.

Accelerators and curing agents were added to the SSBR in the second Banbury pass followed by further mixing and cooling on the two-roll mill set at 35° C. All batches were sheeted off at approximately 2.5 mm to the formulations to facilitate making slabs for testing.

The results of the measurements are summarized in the following Table 6.

TABLE 6
Results from SSBR Batches Banbury Mixed to 3.5 Minutes.

| | | | PPD ACB | | |
|---|---|---|---|---|---|
| | | | Vulkanox ® | Vulkanox ® | In situ |
| | In situ 6-PPD | QDI-ACB | 4030 ACB | 4020 ACB | 6-QDI |
| Carbon black A# | A-14432 | A-19630 | A-19629 | A-19628 | A-14432 |

MDR Rheology at 153° C.
ASTM D5289

| | | | | | |
|---|---|---|---|---|---|
| M_{L} (dNm) | 3.5 | 3.5 | 3.4 | 3.4 | 3.6 |
| M_{H} (dNm) | 20.5 | 20.7 | 20.2 | 20.6 | 20.8 |
| M_{H}-M_{L} (dNm) | 17.0 | 17.2 | 16.8 | 17.1 | 17.2 |
| Ts2 (minutes) | 6.62 | 5.26 | 3.63 | 5.64 | 5.86 |
| T90 (minutes) | 14.01 | 11.96 | 7.77 | 11.71 | 13.11 |
| Cure rate | | | | | |
| (dNm/min) | | | | | |

Dispersion Index
Masterbatch
ASTM D2663

| | | | | | |
|---|---|---|---|---|---|
| F | 40 | 32 | 21 | 42 | 39 |
| H | 2.3 | 2.3 | 3.0 | 2.1 | 2.7 |
| F²H | 3720 | 2633 | 1347 | 3692 | 4200 |
| DI | 90.0 | 92.2 | 94.9 | 90.1 | 89.2 |
| SD | 3.5 | 4.3 | 6.2 | 3.2 | 4.3 |

Mixing characteristics
100° F., 65 rpm, 3.5 min

| | | | | | |
|---|---|---|---|---|---|
| Drop temp | 135 | 148 | 147 | 141 | 148 |
| Mixing energy | 136.8 | 136.7 | 135.2 | 132.9 | 131.4 |
| (W*Hr) | | | | | |

Viscosity and Scorch at 121° C.
ASTM D1646

| | | | | | |
|---|---|---|---|---|---|
| MV initial | 117 | 114 | 115 | 110 | 114 |
| ML1 + 4 | 87 | 85 | 85 | 83 | 85 |
| MV minimum | 86 | 84 | 84 | 81 | 84 |
| Ts2 (min) | 15.00 | 18.28 | 14.72 | 21.53 | 22.54 |
| Ts5 (min) | 33.05 | 24.73 | 17.94 | 29.17 | 29.94 |

Viscosity at 100° C.
ASTM D1646

| | | | | | |
|---|---|---|---|---|---|
| MV initial | 142 | 138 | 142 | 139 | 137 |
| ML1 + 4 | 109 | 107 | 108 | 106 | 108 |

Apparent viscosity-MPT
ASTM D5099

| | | | | | |
|---|---|---|---|---|---|
| Shear rate (s⁻¹) | | | | | |
| 21.9 | 5912 | 5273 | 5473 | 5353 | 5353 |
| 102.2 | 3022 | 2868 | 3013 | 2885 | 2902 |
| 456.0 | 1078 | 1068 | 1076 | 1047 | 1095 |
| 2029.4 | 295 | 293 | 296 | 287 | 300 |

Stress Strain Characteristics
ASTM D412

| | | | | | |
|---|---|---|---|---|---|
| M100% | 2.8 | 2.9 | 2.8 | 2.8 | 3.1 |
| M200% | 7.4 | 7.4 | 6.9 | 7.3 | 8.1 |
| M300% | 13.0 | 12.7 | 12.0 | 12.8 | 14.0 |
| Tensile | 16.1 | 15.9 | 14.4 | 14.5 | 14.8 |
| Elongation at break | 370 | 370 | 340 | 330 | 320 |
| (%) | | | | | |
| Zwick Rebound | 37.9 | 38.0 | 37.7 | 38.0 | 37.6 |
| (%) | | | | | |
| ASTM D1054 | | | | | |
| Shore A | 67.1 | 67.3 | 67.1 | 67.1 | 68.1 |
| Durometer | | | | | |
| Hardness | | | | | |
| ASTM D2240-97 | | | | | |

### Results of Examples 1-3

Mixing Energy and Batch Temperature at Drop

No discernable trends were found correlating mixing energy or drop temperature with carbon black treatment except that the batches containing additive carbon blacks had slightly higher mixing energies in ESBR. No clearly defined trends were observed for the NR and SSBR batches.

MDR Rheology and Mooney Scorch

In all three recipes, the batches that contained the V4030-ACB exhibited the shortest Mooney scorch and MDR rheometer t90 times. This is consistent with the findings of an earlier study. In that study, it was found that a reduction in the level of accelerators used in the NR/V4030-ACB compound was sufficient to increase the scorch time to approximately match that of the control but with changes in the stress/strain properties. For this reason, accelerator reduction may require a slight increase in sulfur to match the modulus of the control compound.

Depending on how 6-QDI is added to the NR recipe (either in-situ or as an ACB), there is either no effect or the scorch is retarded compared to the 6-PPD in-situ control compound. When added to NR as part of an ACB, 6-QDI appears to have no effect on scorch time. However, when 6-QDI is added in-situ to the NR compound, the scorch time is increased versus the 6-PPD in-situ control and the 6-QDI ACB compound. The retarding effect of 6-QDI added in-situ to a NR compound has been reported in the literature. The absence of this effect in the 6-QDI ACB NR compounds has been suspected in previous work of the assignee and is confirmed here.

Neither the SSBR nor the ESBR compound showed the scorch retardation with 6-QDI added in-situ that was evident in the NR recipe.

Mooney Viscosity and MPT Apparent Viscosity

Comparing ML1+4 at 100° C. results, there is no variation in Mooney viscosity that can be attributed to carbon black treatment for either the SSBR or ESBR compounds. For the SSBR compounds, all viscosity values were found to fall within the range of 106 to 109 Mooney units, which is within the normally accepted testing error of the instrument. For the ESBR compounds, the range of viscosity values was found to be between 59 and 63 Mooney units. Examination of the NR Mooney viscosity results indicates that the compounds containing 6-QDI (in-situ=87MU and ACB=86MU) have directionally lower viscosity levels than the control compound (6-PPD in-situ=92MU). The V4020-ACB and V4030-ACB NR compounds exhibit Mooney viscosities that lie between those of the control and the 6-QDI compounds.

Previously, it was found that increasing mixing time from 3.5 minutes to 4.0 minutes increased the difference in Mooney viscosities between 6-QDI and 6-PPD compounds. However, in this study the longer mixing time was found to increase carbon black dispersion levels to the extent that no differences based on carbon black treatment could be determined.

Consequently, a shorter mixing time was chosen for this study to emphasize dispersion improvements versus viscosity reduction. It is important also to note that the NR used in this study was a controlled viscosity (CV) type that may have served to reduce the spread of viscosities of the mixed compounds. It is possible that using a standard, uncontrolled viscosity crumb rubber such as an SMR-L or SMR-10 would increase the effects of the ACB on viscosity. Uncontrolled viscosity grades of natural rubber are more commonly used than CV types due to the higher cost of the CV types.

Monsanto Processability Tester Apparent Viscosity

Testing was conducted at shear rates ranging from 21.9 s⁻¹ up to 2029 s⁻¹ for all three polymer systems. It must be noted that the maximum difference found between the highest and lowest apparent viscosities within any polymer system was less than ten percent at the lowest shear rate. At higher shear rates the spread in the data was even less. Considering the advanced age of the MPT instrument, drawing conclusions beyond a rank ordering of the compounds would be tenuous at best. In all three recipes at the lowest shear rate it was found that the 6-PPD in-situ control compounds exhibited the highest apparent viscosity. In the ESBR and NR compounds, the control was followed in order of decreasing apparent viscosity by V4030-ACB, V4020-ACB, 6-QDI ACB, and finally the 6-QDI in-situ compound. In the SSBR recipe, the rank ordering from highest to lowest apparent viscosity was 6-PPD in-situ control, V4030-ACB, V4020-ACB, 6-QDI in-situ, 6-QDI ACB. In all three polymer systems, the 6-QDI ACB compounds exhibited the lowest apparent viscosities of the three ACBs tested. It appears that the V4030-ACB is less efficient than 6-QDI ACB at reducing apparent viscosity. This is in agreement with the findings of an earlier study, as well as the Mooney viscosity results discussed above.

Stress/Strain Properties

Within each polymer system, the V4030-ACB compounds exhibited the lowest 200% and 300% modulus values of all compounds within each group. The 100% modulus for the V4030-ACB compounds were similar to the other recipes except for in the case of NR wherein the Vulkanox® 4030 compound exhibited a 100% modulus that was slightly lower than the other compounds.

Tensile strengths of the ESBR compounds did not show an effect that could be correlated with carbon black treatment. The SSBR compounds containing Vulkanox® 4030, Vulkanox® 4020, and 6-QDI in-situ exhibited significantly reduced tensile (decreased by 1.3 to 1.7 MPa) compared to the control and 6-QDI ACB compounds. In the NR recipe, the V4030-ACB compound exhibited a significantly reduced tensile strength (28.8 MPa) versus all the other compounds, which fell within a narrow range between 30.6 and 31.0 MPa. The relatively short scorch time for the V4030-ACB compound discussed above may have led to inefficient cross-link formation and negatively impacted the tensile strength.

Dispersion Index Testing

The results reported here are only from the masterbatches that were soaked in peroxide solution and then press cured. In the ESBR recipe, use of an additive carbon black did not have a measurable effect on the carbon black dispersion under the mixing conditions used. In the SSBR recipe the 6-QDI and V4030-ACB (DI=92.2 and 94.9, respectively) compounds exhibited marginally better dispersion indices versus the 6-PPD in-situ control and 6-QDI in-situ as well as the V4020-ACB compounds (DI=90.0, 89.2, and 90.1, respectively).

Between the 6-QDI ACB and the V4030-ACB compounds, the V4030-ACB compound had the highest dispersion level.

In the NR recipe, it was found that use of ACBs significantly enhanced dispersion of the carbon black. The three ACBs exhibited dispersion index results in the range of 91.2 to 95.5 versus 77.1 and 77.2, respectively, for the in-situ 6-PPD and 6-QDI compounds. Of the three ACBs, the V4030-ACB gave the highest dispersion level (DI=95.5), followed by V4020-ACB (DI=93.3) and then the 6-QDI ACB (DI=91.2). This same rank ordering was found during a previous NR study. The fact that the V4030-ACB gave directionally better results in the SSBR recipe and measurably better DIs in the NR recipe suggesting that the dispersion enhancement is significant and repeatable.

Conclusions

It is clear that V4030-ACB provides a dispersion advantage over 6-QDI ACB in NR and possibly in SSBR as well. It also appears that V4020-ACB holds promise as a dispersion aid and has an advantage over the other two ACBs tested due to the fact the Vulkanox® 4020 (Bayer 6-PPD) is already widely used in the tire industry. The 6-QDI ACB seems to combine improved carbon black dispersion with measurable Mooney viscosity reduction versus compounds with 6-PPD added in-situ. However, using either Vulkanox® 4030 or 4020 ACB in conjunction with a small amount of a processing aid could easily offset the viscosity reduction seen with the 6-QDI ACB. The only negative property found for the V4030-ACB was that it significantly reduced the scorch times for the compounds that incorporated it. Obviously, adjusting the cure package as needed to reduce or eliminate this effect or adjusting the temperature could easily compensate for this negative response.

### Example 4

### Comparative Testing Method of Making ACBs

Methods and Materials

Carbon Black

TABLE 7
Carbon black characteristics.

| A Number | Grade | NSA (m²/g) | STSA (m²/g) | DBPA (ml/100 g) |
|---|---|---|---|---|
| A-19006 | N121 | 119 | 116.1 | 128.6 |
| A-20649 | N220 | 110.2 | 105.3 | 114.7 |
| A-22669 | N326 | 76.8 | 76.8 | 70.2 |
| A-22319 | N339 | 93.6 | 90.5 | 120.3 |
| A-22668 | N375 | 95.8 | 91.7 | 114.4 |

The carbon blacks were chosen to give a range of surface areas and structure levels. The carbon blacks were micropulverized to powder to ensure consistency of carbon black between samples. The carbon black was then rebeaded by placing the micropulverized carbon black in a lab scale wet beader with sufficient water to rebead the carbon black (1:1 by weight). The rebeaded carbon black was then dried overnight in an oven at 125° C.

The control non-treated carbon blacks were used from this rebeaded carbon black.

Antioxidant Additives

Vulkanox® 4030 (77PD) (Bayer Corporation, Akron, Ohio) was used as the carbon black additive. Vulkanox® 4030 is a low viscosity liquid antioxidant. 6-PPD (Flexsys America L.P., Akron, Ohio) and Vulkanox® 4030 were used as controls.

6-PPD was utilized to determine the effects of the Vulkanox® 4030 on the scorch times of the polymer compositions.

Additive Carbon Blacks (ACBs)

'547 Patent Method

The Bridgestone '547 patent ACBs (BFS ACB) were made by placing the carbon black in a lab scale wet beader followed by a water/additive mixture. 1000-1200 ml of water (higher structure carbon black requires higher amount of water, lower structure requires less) with 40 g of additive and 1000 g carbon black were used. The beader was rotated for 1 minute then scraped and rotated for 1 additional minute.

Then the ACB was dried according to the method at 125° C. for a minimum of 2.5 hours or a maximum of 3 hours. This was a sufficient amount of time that produced no steam from the Banbury when the ACB was mixed into the polymer composition.

Method of Current Invention

The ACBs (CCC ACB) of the current invention were made by spraying the dry, rebeaded carbon black with additive. 4.0 parts by weight additive and 100 parts by weight carbon black were used.

Polymer

Control viscosity type SMR CV60 natural rubber was used.

Compounding Ingredients

The compounding ingredients used were standard rubber chemicals.

Polymer Compositions

The recipes used are shown in Table 8. The control samples contained either 6-PPD or Vulkanox® 4030 antidegradant added in-situ (during the mixing process rather than in the ACB). The ACBs were used without adding additional antidegradant.

TABLE 8
Recipes used for comparative testing (parts by weight).

| | 6-PPD control | 77PD control | | |
|---|---|---|---|---|
| Ingredient | in situ | in situ | CCC ACB | BFS ACB |
| SMR CV60 | 100 | 100 | 100 | 100 |
| Carbon black | 45 | 45 | — | — |
| Additive | — | — | 46.8 | 46.8 |
| carbon black | | | | |
| Zinc oxide | 4.0 | 4.0 | 4.0 | 4.0 |
| Stearic acid | 3.0 | 3.0 | 3.0 | 3.0 |
| 6-PPD | 1.8 | — | — | — |
| Vulkanox® | — | 1.8 | — | — |
| 4030 liquid | | | | |
| OBTS* | 1.0 | 1.0 | 1.0 | 1.0 |
| Sulfur | 1.5 | 1.5 | 1.5 | 1.5 |

* OBTS = AMAX accelerator (R.T. Vanderbilt Company, Inc., Norwalk, CT).

Mixing

The mixing cycle is shown in Table 9. Mixing was conducted using a lab scale Banbury internal mixer equipped with a watt-hour power integrator for measuring power consumption during mixing. Batch temperatures at drop were recorded using an insertion probe pyrometer. The mix cycle was developed through previous work with ACBs. The cycle is intended to differentiate between highly dispersible carbon blacks (e.g., ACBs) versus standard carbon blacks. The total mixing time of 3.5 minutes has shown itself to be a minimum time required to incorporate non-ACB carbon blacks without overmixing compounds containing ACBs. In formulations that contain a chemical peptizer as an additive (e.g., 6-QDI) versus those that do not, this minimized mixing time tends to reduce the differences in Mooney viscosity seen at longer mixing times. A minimized mixing time may not, therefore, be adequate to see differences that may be apparent at longer mixing times.

TABLE 9
Mix cycle.
Stage 1
Banbury at 100° F., 65 rpm, and 70% fill factor.

| Step | Operation | Time | Temperature |
|---|---|---|---|
| 1 | Add Polymer | 0 | |
| 2 | Add ½ carbon black | 0.5 | |
| | and dry ingredients | | |
| 3 | Add ½ carbon black | 1.5 | |
| | and oil | | |
| 4 | Sweep | 2.5 | |
| 5 | Dump | 3.5 | 320° F. |
| 6 | Pass through 2x | | |
| | without banding | | |
| | and cool 1 hr | | |
| | minimum | | |

Stage 2
Set mill temperature at 80° C.

| | |
|---|---|
| 7 | Band for 30 sec |
| 8 | Add cure; do not cut until cure |
| | incorporated |
| 9 | X cut and roll 6x |
| 10 | Roll end for end 3x |
| 11 | Band sheet off for s/s |

Testing

Mixing energy, temperature at batch drop, percent recovery, masterbatch dispersion index, Mooney viscosity and scorch, rheometer cure properties, stress/strain properties and Shore A durometer hardness were tested for all samples. In addition, finished compound dispersion indexes were measured for batches containing N326 due to the low carbon black dispersions found for the masterbatches. This was done to ensure that carbon black dispersions were sufficient to yield meaningful results in forward testing. Test method numbers are as follows.

TABLE 10
Testing methods.

| Test | Method Used |
|---|---|
| MDR Rheometer Cure Properties at | ASTM D5289 |
| 153° C. | |
| Mooney Viscosity and Scorch, large rotor, | ASTM D1646 |
| 121° C. | |
| Stress Strain Characteristics | ASTM D412 |
| Dispersion Index | LS5-402 (ASTM D2663 |
| | Method C) |
| Shore A Durometer Hardness | ASTM D2240 |

Results

Results are shown in Tables 11-15. Three of the four N121 polymer compositions were re-mixed from scratch and re-tested due to suspect data. While retesting was indicated for N121 with 6-PPD added in situ, there was insufficient carbon black to allow re-mixing. The N375 BFS ACB polymer composition was also re-mixed from scratch due to lower than expected modulus, hardness, and Mooney viscosity; the re-mix results were consistent with the first batch results.

TABLE 11
N121 carbon black polymer compositions.

| | | | |
|---|---|---|---|
| 6-PPD in situ | 77PD in situ | CCC ACB | BFS ACB |

MDR Rheometer Cure Properties at 153° C.

| | | | | |
|---|---|---|---|---|
| M_{L} (dNm) | 1.6 | 2.8 | 2.8 | 2.6 |
| M_{H} (dNm) | 9.1 | 16.9 | 18.9 | 18.3 |
| M_{H}-M_{L} (dNm) | 7.6 | 14.1 | 16.0 | 15.7 |
| Ts2 (minutes) | 2.2 | 2.4 | 1.9 | 2.1 |
| T90 (minutes) | 5.3 | 6.2 | 5.5 | 5.9 |

Mooney Viscosity and Scorch at 121° C.

| | | | | |
|---|---|---|---|---|
| Initial MV | 47 | 71 | 76 | 69 |
| Minimum | 32 | 54 | 58 | 54 |
| ML1 + 4 | 32 | 55 | 559 | 54 |
| TS2 (minutes) | 11.4 | 10.6 | 8.8 | 9.6 |
| TS5 (minutes) | 13.1 | 14.0 | 10.0 | 12.1 |
| TS25 (minutes) | 15.1 | 14.3 | 11.8 | 15.0 |

Stress Strain Characteristics

| | | | | |
|---|---|---|---|---|
| M100% (MPa) | 1.6 | 2.4 | 2.7 | 2.6 |
| M200% (MPa) | 3.4 | 6.3 | 7.0 | 6.5 |
| M300% (MPa) | 6.8 | 11.7 | 12.7 | 11.9 |
| Tensile (MPa) | 25.5 | 29.1 | 29.6 | 29.8 |
| Elongation to | 630 | 590 | 580 | 600 |
| break (%) | | | | |

Dispersion Index
Masterbatch

| | | | | |
|---|---|---|---|---|
| F | 65 | 55 | 29 | 31 |
| H | 1.8 | 2.3 | 2.4 | 2.2 |
| F²H | 8024 | 7092 | 1951 | 2126 |
| SD | 1.3 | 2.7 | 3.9 | 4.5 |
| DI | 71.6 | 73.7 | 90.5 | 89.7 |

Dispersion Index
Finished batch

| | | | | |
|---|---|---|---|---|
| F | ND | ND | ND | ND |
| H | ND | ND | ND | ND |
| F²H | ND | ND | ND | ND |
| SD | ND | ND | ND | ND |
| DI | ND | ND | ND | ND |
| Shore A | ND | 63 | 65 | 66 |
| Durometer | | | | |
| Hardness | | | | |

ND = test not performed (not done)

TABLE 12
N220 carbon black polymer compositions.

| | | | |
|---|---|---|---|
| 6PPD in situ | 77PD in situ | CCC ACB | BFS AC |

MDR Rheometer Cure Properties at 153° C.

| | | | | |
|---|---|---|---|---|
| M_{L} (dNm) | 2.2 | 2.5 | 2.7 | 1.9 |
| M_{H} (dNm) | 15.7 | 15.8 | 17.0 | 14.4 |
| M_{H}-M_{L} (dNm) | 13.4 | 13.4 | 14.3 | 12.5 |
| Ts2 (minutes) | 3.1 | 3.0 | 2.9 | 1.4 |
| T90 (minutes) | 7.1 | 6.9 | 7.0 | 3.7 |

Mooney Viscosity and Scorch at 121° C.

| | | | | |
|---|---|---|---|---|
| Initial MV47 | 65 | 69 | 80 | 63 |
| Minimum | 43 | 47 | 51 | 41 |
| ML1 + 4 | 46 | 48 | 51 | 42 |
| TS2 (minutes) | 21.0 | 13.8 | 6.4 | 8.5 |
| TS5 (minutes) | 23.3 | 15.2 | 7.2 | 9.9 |
| TS25 (minutes) | 26.2 | 16.9 | 8.3 | 12.1 |

Stress Strain Characteristics

| | | | | |
|---|---|---|---|---|
| M100% (MPa) | 2.2 | 1.9 | 2.4 | 2.2 |
| M200% (MPa) | 5.2 | 4.6 | 5.8 | 5.0 |
| M300% (MPa) | 9.7 | 8.8 | 10.7 | 9.3 |
| Tensile (MPa) | 28.5 | 29.5 | 30.0 | 27.1 |
| Elongation to | 640 | 680 | 620 | 600 |
| break (%) | | | | |

Dispersion Index
Masterbatch

| | | | | |
|---|---|---|---|---|
| F | 62 | 38 | 24 | 31 |
| H | 1.9 | 2.0 | 2.5 | 2.4 |
| F²H | 7610 | 3060 | 1385 | 2380 |
| SD | 2.7 | 2.0 | 3.1 | 3.0 |
| DI | 72.7 | 86.8 | 92.8 | 89.2 |

Dispersion Index
Finished batch

| | | | | |
|---|---|---|---|---|
| F | ND | ND | ND | ND |
| H | ND | ND | ND | ND |
| F²H | ND | ND | ND | ND |
| SD | ND | ND | ND | ND |
| DI | ND | ND | ND | ND |
| Shore A | ND | ND | ND | ND |
| Durometer | | | | |
| Hardness | | | | |

ND = test not performed (not done)

TABLE 13
N326 carbon black polymer compositions.

| | | | |
|---|---|---|---|
| 6-PPD in situ | 77PD in situ | CCC ACB | BFS ACB |

MDR Rheometer Cure Properties at 153° C.

| | | | | |
|---|---|---|---|---|
| M_{L} (dNm) | 2.2 | 2.0 | 2.0 | 1.6 |
| M_{H} (dNm) | 14.4 | 14.0 | 14.8 | 14.5 |
| M_{H}-M_{L} (dNm) | 12.2 | 11.9 | 12.8 | 12.9 |
| Ts2 (minutes) | 3.5 | 2.5 | 1.6 | 1.7 |
| T90 (minutes) | 8.3 | 6.3 | 4.7 | 4.5 |
| Initial MV47 | 62 | 51 | 51 | 45 |
| Minimum | 41 | 38 | 37 | 33 |
| ML1 + 4 | 41 | 38 | 38 | 33 |
| TS2 (minutes) | 19.9 | 10.7 | 7.3 | 7.5 |
| TS5 (minutes) | 22.3 | 11.8 | 8.4 | 9.1 |
| TS25 (minutes) | 25.5 | 13.1 | 10.3 | 11.5 |

Stress Strain Characteristics

| | | | | |
|---|---|---|---|---|
| M100% (MPa) | 1.8 | 1.7 | 1.8 | 1.8 |
| M200% (MPa) | 4.3 | 4.1 | 4.0 | 3.8 |
| M300% (MPa) | 8.5 | 8.0 | 7.4 | 7.0 |
| Tensile (MPa) | 30.3 | 30.5 | 28.7 | 29.3 |
| Elongation to | 660 | 680 | 660 | 670 |
| break (%) | | | | |

Dispersion Index
Masterbatch

| | | | | |
|---|---|---|---|---|
| F | 89 | 128 | 86 | 81 |
| H | 2.2 | 2.5 | 2.1 | 2.1 |
| F²H | 15277 | 41190 | 15919 | 13768 |
| SD | 2.6 | 1.6 | 1.8 | 1.5 |
| DI | 44.4 | 0.0 | 50.3 | 55.6 |

Dispersion Index
Finished batch

| | | | | |
|---|---|---|---|---|
| F | 9 | 10 | 13 | 17 |
| H | 3.0 | 3.7 | 2.5 | 2.0 |
| F²H | 285 | 337 | 392 | 590 |
| SD | 2.1 | 4.4 | 1.5 | 1.3 |
| DI | 97.9 | 97.5 | 97.2 | 96.2 |
| Shore A | 58 | 58 | 60 | 60 |
| Durometer | | | | |
| Hardness | | | | |

ND = test not performed (not done)

TABLE 14
N339 carbon black polymer compositions.

| | | | |
|---|---|---|---|
| 6-PPD in situ | 77PD in situ | CCC ACB | BFS ACB |

MDR Rheometer Cure Properties at 153° C.

| | | | | |
|---|---|---|---|---|
| M_{L} (dNm) | 2.4 | 2.6 | 2.1 | 1.9 |
| M_{H} (dNm) | 14.4 | 13.9 | 15.1 | 14.7 |
| M_{H}-M_{L} (dNm) | 14.4 | 13.9 | 15.1 | 14.7 |
| Ts2 (minutes) | 3. | 2.2 | 2.0 | 1.7 |
| T90 (minutes) | 8.2 | 6.4 | 5.5 | 4.7 |

Mooney Viscosity and Scorch at 121° C.

| | | | | |
|---|---|---|---|---|
| Initial MV | 69 | 74 | 70 | 56 |
| Minimum | 46 | 53 | 43 | 41 |
| ML1 + 4 | 48 | 53 | 46 | 42 |
| TS2 (minutes) | 20.8 | 10.7 | 11.7 | 7.8 |
| TS5 (minutes) | 22.9 | 11.8 | 13.1 | 9.4 |
| TS25 (minutes) | 25.4 | 12.9 | 15.3 | 11.6 |

Stress Strain Characteristics

| | | | | |
|---|---|---|---|---|
| M100% (MPa) | 2.4 | 2.4 | 2.4 | 2.4 |
| M200% (MPa) | 6.9 | 6.8 | 6.3 | 5.9 |
| M300% (MPa) | 13.1 | 12.7 | 11.5 | 10.8 |
| Tensile (MPa) | 30.6 | 31.1 | 28.8 | 28.8 |
| Elongation to | 600 | 610 | 610 | 620 |
| break (%) | | | | |

Dispersion Index
Masterbatch

| | | | | |
|---|---|---|---|---|
| F | 24.5 | 25.5 | 2.4 | 2.4 |
| H | 2.05 | 1.6 | 3.55 | 1.5 |
| F²H | 1300 | 1089 | 240 | 570 |
| SD | 3.0 | 0.9 | 2.8 | 0.7 |
| DI | 93.2 | 94.1 | 98.2 | 96.4 |

Dispersion Index
Finished batch

| | | | | |
|---|---|---|---|---|
| F | ND | ND | ND | ND |
| H | ND | ND | ND | ND |
| F²H | ND | ND | ND | ND |
| SD | ND | ND | ND | ND |
| DI | ND | ND | ND | ND |
| Shore A | 63 | 63 | 65 | 65 |
| Durometer | | | | |
| Hardness | | | | |

ND = test not performed (not done)

TABLE 15
N375 carbon black polymer compositions.

| | | | |
|---|---|---|---|
| 6-PPD in situ | 77PD in situ | CCC ACB | BFS ACB |

MDR Rheometer Cure Properties at 153° C.

| | | | | |
|---|---|---|---|---|
| M_{L} (dNm) | 2.2 | 2.4 | 2.4 | 1.6 |
| M_{H} (dNm) | | | | |
| M_{H}-M_{L} (dNm) | 13.6 | 13.3 | 14.7 | 11.8 |
| Ts2 (minutes) | 2.9 | 2.7 | 1.8 | 1.4 |
| T90 (minutes) | 7.1 | 6.7 | 5.1 | 3.6 |

Mooney Viscosity and Scorch at 121° C.

| | | | | |
|---|---|---|---|---|
| Initial MV | 65 | 68 | 72 | 48 |
| Minimum | 44 | 48 | 48 | 35 |
| ML1 + 4 | 45 | 49 | 50 | 35 |
| TS2 (minutes) | 20.2 | 14.3 | 10.1 | 6.2 |
| TS5 (minutes) | 21.9 | 15.6 | 11.1 | 7.3 |
| TS25 (minutes) | 24.3 | 16.9 | 13.0 | 8.9 |

Stress Strain Characteristics

| | | | | |
|---|---|---|---|---|
| M100% (MPa) | 2.1 | 2.3 | 2.3 | 1.9 |
| M200% (MPa) | 5.3 | 6.1 | 5.8 | 4.3 |
| M300% (MPa) | 10.3 | 11.6 | 11.0 | 8.4 |
| Tensile (MPa) | 28.3 | 31.0 | 28.9 | 27.8 |
| Elongation to | 630 | 630 | 610 | 610 |
| break (%) | | | | |

Dispersion Index
Masterbatch

| | | | | |
|---|---|---|---|---|
| F | 63 | 68.5 | 29.5 | 37.5 |
| H | 1.8 | 1.6 | 1.8 | 1.6 |
| F²H | 7469 | 7944 | 1629 | 2341 |
| SD | 1.3 | 1.2 | 1.5 | 1.2 |
| DI | 72.9 | 72.2 | 91.8 | 89.1 |

Dispersion Index
Finished batch

| | | | | |
|---|---|---|---|---|
| F | ND | ND | ND | ND |
| H | ND | ND | ND | ND |
| F²H | ND | ND | ND | ND |
| SD | ND | ND | ND | ND |
| DI | ND | ND | ND | ND |
| Shore A | 62 | 61 | 65 | 60 |
| Durometer | | | | |
| Hardness | | | | |

ND = test not performed (not done)

In all cases, carbon black dispersion for the ACBs at the masterbatch stage of mixing in each carbon black grade were improved versus the controls containing untreated carbon black.

With the exception of N326, the batches containing CCC ACB exhibited equal or better carbon black dispersion than did those containing BFS ACB. In the N326 compositions, however, carbon black dispersion for the two ACB compounds were found to be between 50 and 60% which is very low compared to the other compounds in the study. According to ASTM D2663, at this level of dispersion, the level of uncertainty is very high, indicating there may be no significant performance differences between the compositions containing CCC ACB and BFS ACB for the N326 carbon black.

In general, rheometer scorch times (ts2) for the compositions containing Vulkanox® 4030 (in situ and ACB) were significantly shorter than for the compositions containing 6-PPD. T90 times were also reduced with the exception of the N121 compositions. In all cases, Mooney scorch times were significantly reduced compared to the 6-PPD compositions.

In all cases, the compositions containing BFS ACB exhibited the Mooney viscosities which were either the lowest of the four compositions or equal to the lowest Mooney viscosity. The other compositions appear to vary randomly with respect to rank order for Mooney viscosity.

In general, Shore A durometer hardness values for the batches containing ACB were 2-4 units higher than those for the batches containing untreated carbon black. It is possible that this is a function of carbon black dispersion. The exception is for the N375 composition containing BFS ACB. The N375 BFS ACB composition had the same Shore A hardness as the batches that contained the untreated carbon black and a significantly lower Mooney viscosity than the other 3 batches containing N375.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for producing an additive carbon black comprising combining substantially neat amine antidegradant and carbon black.

2. The method of claim 1 wherein the amine antidegradant is neat.

3. The method of claim 1 wherein the amine antidegradant comprises naphthylamine, naphthylamine derivative, diphenylamine, diphenylamine derivative, p-phenylenediamine, p-phenylenediamine derivative, other amine compound, or a mixture thereof.

4. The method of claim 1 wherein the amine antidegradant comprises p-phenylenediamine (PPD) or a p-phenylenediamine derivative.

5. The method of claim 1 wherein the amine antidegradant comprises N-(1,3-dimethylbutyl)-N′-phenyl-p-phenylenediamine) (6-PPD).

6. The method of claim 1 wherein the amine antidegradant comprises (N,N′-bis-(1,4-dimethylpentyl)-p-phenylenediamine) (77-PD).

7. The method of claim 1 wherein the amine antidegradant comprises at least one naphthylamine derivative comprising N-phenyl-1-naphthylamine, N-phenyl-2-naphthylamine, N-(3′-hydroxybutylidene)-1-naphthylamine, a reaction product of N-phenyl-2-naphthylamine and acetone, or a reaction product at low temperature of N-phenyl-2-naphthylamine and acetone.

8. The method of claim 1 wherein the amine antidegradant comprises at least one diphenylamine derivative comprising isopropoxydiphenylamine, bis(phenyl.iso-propylidene)-4,4′-diphenylamine, p,p′-toluene.sulfonylamino-diphenylamine, 4,4′-(α,α-dimethyl.benzyl)-diphenylamine, mixture of di-aryl-p-phenylenediamine, N,N′-diphenylethylenediamine, N,N′-diphenylpropylenediamine, a reaction product at high temperature of diphenylamine and acetone, a reaction product at low temperature of diphenylamine and acetone, a reaction product at low temperature of diphenylamine-aniline and acetone, a reaction product of diphenylamine and diisobutylene, octylated diphenylamine, nonylated diphenylamine, displaced diphenylamine, alkylated diphenylamine, a mixture of alkylated diphenylamine, a blend of the mixture of diphenylamine and petroleum wax, or derivative of diphenylamine.

9. The method of claim 1 wherein the amine antidegradant comprises at least one p-phenylenediamine derivative comprising N,N′-diphenyl-p-phenylenediamine, N,N′-di-2-naphthyl-p-phenylenediamine, N,N′-bis(1-methylheptyl)-p-phenylenediamine, N,N′-bis(1,4-dimethylpentyl)-p-phenylenediamine, N,N′-bis(1-ethyl-3-methylpentyl)-p-phenylenediamine, N,N′-diaryl-p-phenylenediamine, N-isopropyl-N′-phenyl-p-phenylenediamine, N-cyclohexyl-N′-phenyl-p-phenylenediamine, N-alkyl-N′-phenyl-p-phenylenediamine, N-alkyl-N′-aryl-p-phenylenediamine, N-4-methyl-2-pentyl-N′-phenyl-p-phenylenediamine, N-(1,3-dimethylbutyl)-N′-phenyl-p-phenylenediamine, N-(1-methylheptyl)-N′-phenyl-p-phenylenediamine, N-phenyl-N′-(3-methacryloyloxy-2-hydroxypropyl)-p-phenylenediamine, hindered.diaryl-p-phenylenediamine, phenylhexyl-p-phenylenediamine, phenyloctyl-p-phenylenediamine or a mixture of diaryl-p-phenylenediamine.

10. The method of claim 1 wherein the amine antidegradant comprises at least one suitable amine compound comprising N,N′-di-o-toryl.ethylenediamine, N,N′-disarylcilidene-1,2-propanediamine, a reaction product of amine and ketone, derivative of aromatic amines or a condensation product of butylaldehyde and aniline.

11. The method of claim 1 wherein the carbon black is surface treated with the amine antidegradant.

12. The method of claim 1 wherein the combination occurs by spraying the amine antidegradant on the carbon black.

13. The method of claim 1 wherein the combination occurs by beading the carbon black with the amine antidegradant.

14. The method of claim 1 wherein the ratio of amine antidegradant to carbon black is from about 0.01 to about 8 parts by weight antidegradant to about 100 parts by weight carbon black.

15. The method of claim 1 wherein the ratio of amine antidegradant to carbon black is from about 1.8-about 2 parts by weight antidegradant to about 45-about 50 parts by weight carbon black.

16. An additive carbon black made by the method of claim 1.

17. A method for producing a surface-treated additive carbon black comprising combining carbon black with an amine antidegradant, wherein the combination occurs substantially free of a solvent or carrier.

18. The method of claim 17 wherein the combination occurs in the absence of a solvent or carrier.

19. The method of claim 17 wherein the amine antidegradant comprises naphthylamine, naphthylamine derivative, diphenylamine, diphenylamine derivative, p-phenylenediamine, p-phenylenediamine derivative, other amine compound, or a mixture thereof.

20. The method of claim 17 wherein the amine antidegradant comprises p-phenylenediamine or a p-phenylenediamine derivative.

21. The method of claim 17 wherein the amine antidegradant comprises N-(1,3-dimethylbutyl)-N′-phenyl-p-phenylenediamine) (6-PPD).

22. The method of claim 17 wherein the amine antidegradant comprises (N,N′-bis-(1,4-dimethylpentyl)-p-phenylenediamine) (77-PD).

23. The method of claim 17 wherein the amine antidegradant comprises at least one naphthylamine derivative comprising N-phenyl-1-naphthylamine, N-phenyl-2-naphthylamine, N-(3′-hydroxybutylidene)-1-naphthylamine, a reaction product of N-phenyl-2-naphthylamine and acetone, or a reaction product at low temperature of N-phenyl-2-naphthylamine and acetone.

24. The method of claim 17 wherein the amine antidegradant comprises at least one diphenylamine derivative comprising isopropoxydiphenylamine, bis(phenyl.iso-propylidene)-4,4′-diphenylamine, p,p′-toluene.sulfonylamino-diphenylamine, 4,4′-(α,α-dimethyl.benzyl)-diphenylamine, mixture of di-aryl-p-phenylenediamine, N,N′-diphenylethylenediamine, N,N′-diphenylpropylenediamine, a reaction product at high temperature of diphenylamine and acetone, a reaction product at low temperature of diphenylamine and acetone, a reaction product at low temperature of diphenylamine-aniline and acetone, a reaction product of diphenylamine and diisobutylene, octylated diphenylamine, nonylated diphenylamine, displaced diphenylamine, alkylated diphenylamine, a mixture of alkylated diphenylamine, a blend of the mixture of diphenylamine and petroleum wax, or derivative of diphenylamine.

25. The method of claim 17 wherein the amine antidegradant comprises at least one p-phenylenediamine derivative comprising N,N′-diphenyl-p-phenylenediamine, N,N′-di-2-naphthyl-p-phenylenediamine, N,N′-bis(1-methylheptyl)-p-phenylenediamine, N,N′-bis(1,4-dimethylpentyl)-p-phenylenediamine, N,N′-bis(1-ethyl-3-methylpentyl)-p-phenylenediamine, N,N′-diaryl-p-phenylenediamine, N-isopropyl-N′-phenyl-p-phenylenediamine, N-cyclohexyl-N′-phenyl-p-phenylenediamine, N-alkyl-N′-phenyl-p-phenylenediamine, N-alkyl-N′-aryl-p-phenylenediamine, N-4-methyl-2-pentyl-N′-phenyl-p-phenylenediamine, N-(1,3-dimethylbutyl)-N′-phenyl-p-phenylenediamine, N-(1-methylheptyl)-N′-phenyl-p-phenylenediamine, N-phenyl-N′-(3-methacryloyloxy-2-hydroxypropyl)-p-phenylenediamine, hindered.diaryl-p-phenylenediamine, phenylhexyl-p-phenylenediamine, phenyloctyl-p-phenylenediamine or a mixture of diaryl-p-phenylenediamine.

26. The method of claim 17 wherein the amine antidegradant comprises at least one suitable amine compound comprising N,N′-di-o-toryl.ethylenediamine, N,N′-disarylcilidene-1,2-propanediamine, a reaction product of amine and ketone, derivative of aromatic amines or a condensation product of butylaldehyde and aniline.

27. The method of claim 17 wherein the carbon black has a surface area of less than or equal to 130 m²/g.

28. The method of claim 17 wherein the combination occurs by spraying the amine antidegradant on the carbon black.

29. The method of claim 17 wherein the combination occurs by beading the carbon black with the amine antidegradant.

30. The method of claim 17 wherein the ratio of amine antidegradant to carbon black is from about 0.01 to about 8 parts by weight antidegradant to about 100 parts by weight carbon black.

31. The method of claim 17 wherein the ratio of amine antidegradant to carbon black is from about 1.8-about 2 parts by weight antidegradant to about 45-about 50 parts by weight carbon black.

32. A method of producing an additive carbon black comprising combining carbon black with a neat amine antidegradant, wherein the carbon black has a surface area of less than or equal to 130 m²/g.

33. The method of claim 32 wherein the carbon black has a surface area of from about 77 to about 119 m²/g.

34. A method of producing an additive carbon black comprising combining carbon black with a substantially neat amine antidegradant, wherein the carbon black has a surface area of less than or equal to 130 m²/g and the amine antidegradant is naphthylamine, naphthylamine derivative, diphenylamine, diphenylamine derivative, p-phenylenediamine, p-phenylenediamine derivative, other amine compound, or a mixture thereof.

35. A method for producing a polymer composition with improved carbon black dispersion characteristics comprising adding an additive carbon black made by the method of claim 1 to a polymer.

36. The method of claim 35 wherein a portion of the additive carbon black is added to the polymer with an additional dry ingredient.

37. The method of claim 36 wherein the remainder of the additive carbon black is added to the polymer with a liquid ingredient.

38. The method of claim 37 wherein the liquid ingredient comprises oil or an oil mixture.

39. The method of claim 36 wherein an additional dry ingredient comprises filler, accelerator, cure activator, fatty acid, fatty acid derivative, wax, peptizer, or vulcanizing agent.

40. The method of claim 37 wherein a liquid ingredient comprises curable resin, prepolymeric liquid, peroxide, or reodorant.

41. The method of claim 35 wherein the additive carbon black is surface treated with a naphthylamine, naphthylamine derivative, diphenylamine, diphenylamine derivative, p-phenylenediamine, p-phenylenediamine derivative, other amine compound, or a mixture thereof.

42. The method of claim 35 wherein the polymer is a natural rubber (NR), a synthetic rubber, or a mixture thereof.

43. The method of claim 42 wherein the polymer is natural rubber.

44. The method of claim 42 wherein the polymer is a styrene-butadiene rubber (SBR).

45. The method of claim 35 wherein the additive carbon black is added to the polymer at from about 10 to about 80 parts by weight carbon black to about 100 parts by weight polymer.

46. The method of claim 35 wherein the additive carbon black is added to the polymer at from about 20 to about 60 parts by weight carbon black to about 100 parts by weight polymer.

47. The method of claim 35 wherein the additive carbon black is added to the polymer at from about 40 to about 60 parts by weight carbon black to about 100 parts by weight polymer.

48. The method of claim 35 wherein the additive carbon black is added to the polymer at from about 52 parts by weight carbon black to about 100 parts by weight polymer.

49. The method of claim 35 wherein the additive carbon black is added to the polymer at from about 47 parts by weight carbon black to about 100 parts by weight polymer.

50. The method of claim 35 wherein the additive carbon black is added to the polymer in an internal mixer.

51. The method of claim 50 wherein the carbon black and polymer are mixed until the carbon black is well dispersed in the polymer.

52. The method of claim 51 further comprising adding an additional ingredient.

53. The method of claim 52 wherein the additional ingredient comprises a curing agent.

54. The method of claim 51 further comprising milling, cooling, extruding, calendering, pelletizing, granulating, grinding, or sheeting.

55. A polymer composition made by the method of claim 35.

56. A method of combining a polymer and a carbon black treated with a solvent-free naphthylamine, naphthylamine derivative, diphenylamine, diphenylamine derivative, p-phenylenediamine, p-phenylenediamine derivative, other amine compound or mixtures thereof, in a first stage comprising
adding to a polymer a first quantity of the treated carbon black; and,
adding to said polymer a second quantity of the treated carbon black with oil or in an oil mixture, wherein a masterbatch is made during the first stage.

57. The method of claim 56 further comprising in a second stage passing the masterbatch twice through a two roll mill for cooling.

58. The method of claim 57 further comprising adding accelerators and curing agents in the second stage followed by further mixing and cooling on a two roll mill, twin screw sheeter or other cooling apparatus.

59. The method of claim 56 wherein the polymer is treated with PPD.

60. The method of claim 56 wherein the polymer includes a natural rubber (NR).

61. The method of claim 56 wherein the polymer includes a solution styrene-butadiene rubber (SSBR).

62. A method for combining a naphthylamine treated, naphthylamine derivative treated, diphenylamine treated, diphenylamine derivative treated, p-phenylenediamine treated, p-phenylenediamine derivative treated or other amine compound, substantially free of solvent, surface-treated carbon black with a polymer, comprising adding to a polymer a mixture comprising the surface-treated carbon black and oil and mixing.

63. The method of claim 62 wherein the treated carbon black is produced in the absence of a solvent.

64. The method of claim 62 further comprising
passing the polymer through a two roll mill for cooling.

65. The method of claim 62 further comprising
adding accelerators and curing agents in a further mixing step.

66. The method of claim 62 wherein the carbon black is treated with PPD.

67. The method of claim 62 wherein the polymer includes NR.

68. The method of claim 62 wherein the polymer includes an SSBR.

69. An article-of-manufacture comprising an additive carbon black produced by the method of claim 1.

70. An article-of-manufacture comprising a surface-treated additive carbon black produced by combining an amine antidegradant with carbon black in the absence of a solvent or carrier.

71. A polymeric article comprising the polymer composition produced by claim 35.

72. The polymeric article of claim 71 wherein the polymer is rubber.

73. The polymeric article of claim 72 wherein the article comprises a tire tread.

74. The polymeric article of claim 72 wherein the article comprises a sheet.

75. A method of forming a polymeric article with well dispersed carbon black comprising making a polymer composition by the method of claim 35 and simultaneously or subsequently forming the polymer composition into an article.

76. The method of claim 75 wherein the forming is done via extrusion, molding, or calendering.
